(19) United States
(12) Patent Application Publication
(10) Pub. No.: US 2013/0179418 A1
(43) Pub. Date: Jul. 11, 2013

(54) SEARCH RANKING FEATURES

(71) Applicants: Øivind Wang, Oslo (NO); Nicolai Bodd, Stabekk (NO); Rune Djurhuus, Oslo (NO)

(72) Inventors: Øivind Wang, Oslo (NO); Nicolai Bodd, Stabekk (NO); Rune Djurhuus, Oslo (NO)

(73) Assignee: MICROSOFT CORPORATION, Redmond, WA (US)

(21) Appl. No.: 13/345,144

(22) Filed: Jan. 6, 2012

(51) Int. Cl. G06F 17/30

(52) U.S. Cl. 707/706; 707/E17.108

(57) ABSTRACT

Search ranking features are described that may be used by a search engine to rank items in a search result. Examples of such features include use of multiple linear ranking stages, use of BM25 and a full text index, use of a minimum span on ranking stages, pre-calculation of a plurality of ranking models, use of a dynamic rank, use of more than one BM25 definition per stage, date/time transformations, freshness transformations, raw value transformations, query property rank, social distance, and so on.

### BACKGROUND

Search has become one of the primary techniques by which a user may interact with a computing device. A user, for instance, may provide one or more keywords to locate an item of interest on a computing device itself, one or more items made available via a network service (e.g., goods and content such as music, books, and videos), and so forth.

However, conventional techniques that were utilized to perform searches could lack relevancy in some situations, such as due to adoption of the conventional techniques for different types of data. Therefore, relevancy used for a search in one type of data may be quite different than that for another type of data.

### SUMMARY

Search ranking features are described that may be used by a search engine to rank items in a search result. Examples of such features include use of multiple linear ranking stages (which may be used to support a variety of different features), use of BM25 and a full text index, use of a minimum span on ranking stages, pre-calculation of a plurality of ranking models, use of a dynamic rank, use of more than one BM25 definition per stage, date/time transformations, freshness transformations, raw value transformations, query property rank, social distance, and so on.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to implement search ranking features described herein.

FIG. 2 is an illustration of a system in an example implementation showing a search engine module of FIG. 1 in greater detail as being incorporated as part of a network service of a network service provider.

FIG. 3 is a flow diagram depicting a procedure in an example implementation in which a search engine module is exposed by a search engine developer for availability to one or more customers, such as a network service provider.

FIG. 4 is a flow diagram depicting a procedure in an example implementation in which the search engine module exposed by the search engine developer in FIG. 3 is obtained by a customer for customization.

FIG. 5 is a flow diagram depicting a procedure in an example implementation in which a customer that obtained the search engine module from the search engine developer provides inputs to customize features used in ranking by the search engine module.

### DETAILED DESCRIPTION

### Overview

Search engines are used to provide search results that are relevant to a user that provided a query to the engine. The evaluation of the relevancy of the data (e.g., documents, music, videos, auction items, pictures, and so on) may be performed by a search core of the search engine and defined using a ranking model. The ranking model may include a set of features that are evaluated for each item of data in a set of results and may be used to contribute to a total ranking score that is utilized to rank the items in relation to each other for output as a search result.

Features are described herein that may be used by a search engine to rank items in a search result. In one or more implementations, the search engine is configured to expose features to customers (e.g., purchasers of the search engine for use as part of a network service) such that the customer may configure the features as desired. Examples of such features include support of multiple linear ranking stages (e.g., which may be used to support a variety of different features), use of BM25 and a full text index, use of a minimum span on ranking stages, pre-calculation of a plurality of ranking models, use of a dynamic rank, use of more than one BM25 definition per stage, date/time transformations, freshness transformations, raw value transformations, query property rank, social distance, and so on. Further discussion of these and other features may be found in relation to the following sections.

In the following discussion, an example environment is first described that may employ the search ranking techniques described herein. Example procedures are then described which may be performed in the example environment as well as other environments. Consequently, performance of the example procedures is not limited to the example environment and the example environment is not limited to performance of the example procedures.

Example Environment

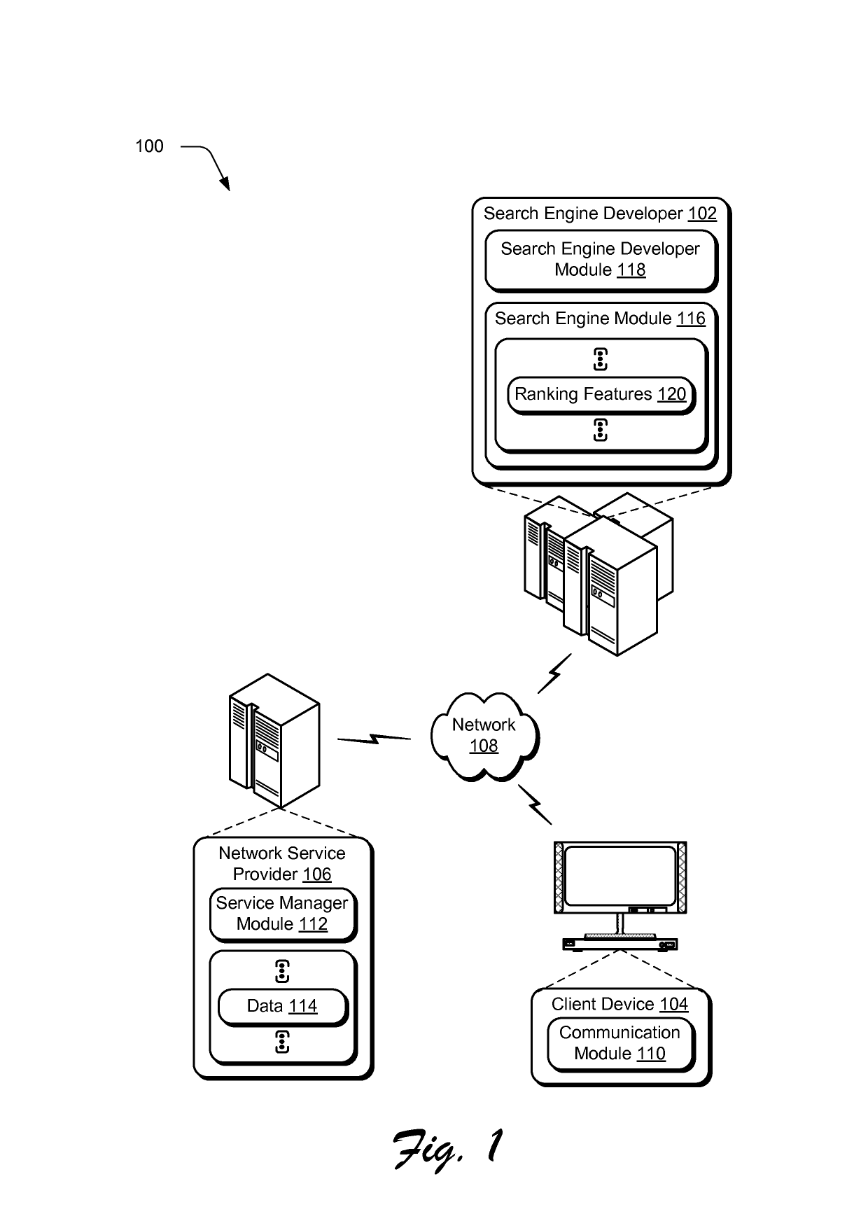

FIG. 1 is an illustration of an environment 100 in an example implementation that is operable to employ search ranking techniques described herein. The illustrated environment 100 includes a search engine developer 102, a client device 104, and a network service provider 106 that are communicatively coupled, one to another, via a network 108. The search engine developer 102, the client device 104, and the network service provider 106 may be implemented by a variety of different configurations of a computing device.

For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, a computing device may range from full resource devices with substantial memory and processor resources (e.g., personal computers, game consoles) to a low-resource device with limited memory and/or processing resources (e.g., traditional set-top boxes, hand-held game consoles). Additionally, a computing device may be representative of a plurality of different devices, such as multiple servers utilized by a business to perform operations as illustrated for the search engine developer 102, a remote control and set-top box combination, an image capture device and a game console configured to capture gestures, and so on.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The client device 104 is illustrated as including a communication module 110. The communication module 110 is representative of functionality of the client device 104 to access the network 108, such as to access one or more network services of the network service provider 106. As such, the communication module 110 may be configured in a variety of ways. Example configurations include a browser, a network-enabled application, a third-party plug-in, and so on.

The network service provider 106 is illustrated as including a service manager module 112. The service manager module 112 is representative of functionality to provide one or more network services that are accessible via the network 108. Network services may be configured to support a variety of different functionality. Examples of network services include an email service, commerce service (e.g., a service to provider goods or services via a user interface that is accessible via the network 108), an internet search service, a content service (e.g., a photo or video sharing service), a social network service, a news service, a blog service, and so on.

As such, data 114 used to support the services that are managed by the service manager module 112 may be configured in a variety of ways. For example, the data 114 may be used to describe content related to the search services, such as metadata describing characteristics of movies, books, music, games, good or services available via the services, and so forth. The data 114 may also be part of a subject of the services itself, such as documents, webpages, indexes, articles, blogs, and so on. Thus, a variety of different data 114 may be made available of the client device 104 via the network.

To enable a user of the client device 104 to locate a particular item of data 114 of interest, the network service provider 106 may obtain a search engine module 116 from the search engine developer 102. The search engine module 116 is representative of functionality to perform a search to provide a search result in response to a search query, e.g., a query received from the client device 104.

The search engine module 116 is illustrated as included as part of a search engine developer 102. The search engine developer 102 is illustrated as including a search engine developer module 118 that is representative of functionality to develop, instantiate, and make the search engine module 116 available. The search engine developer module 118, for instance, may be configured to support techniques to develop a search core of the search engine module 116 that is executable to evaluate relevancy of the data 114 in relation to a search query. This relevancy may be defined using a ranking model, which may leverage a set of ranking features 120. The ranking features 120 are evaluated for each item of data in a set of results for a search query (e.g., received from the client device 104) and may be used to contribute to a total ranking score that is utilized to rank the items in relation to each other for output as a search result.

Thus, in this example the search engine developer 102 may develop a search engine implemented by the search engine module 116 for dissemination to a variety of different customers, such as the network service provider 106 in the illustrated example environment 100. Because of this, the search engine module 116 may encounter a variety of different types of data 114, for which, the search engine module 116 is to determine relevancy for a search query to generate a search result.

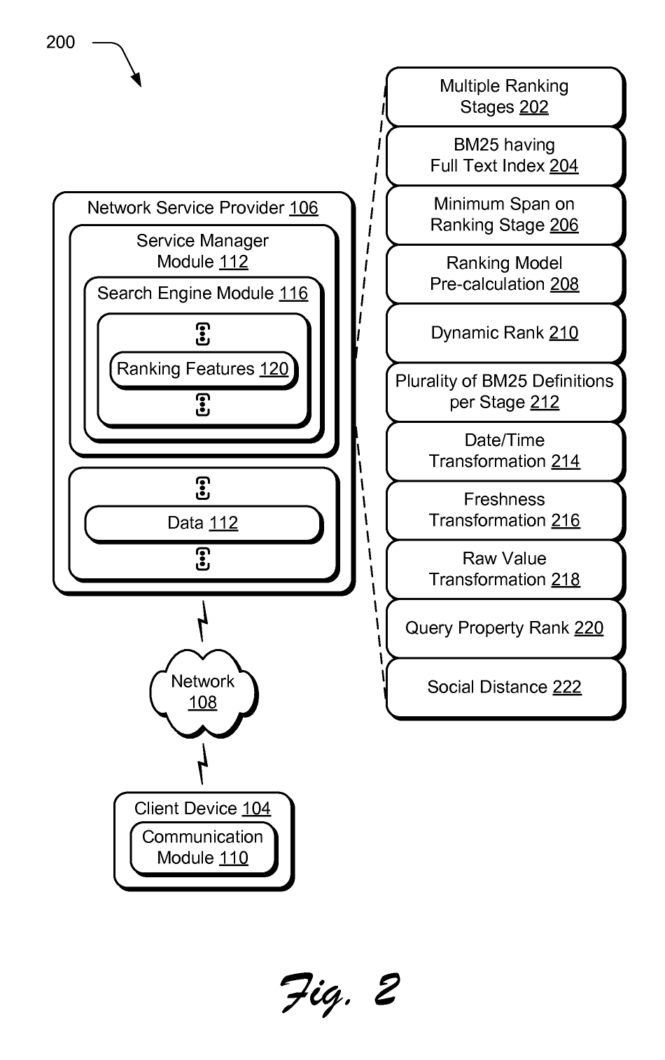

Accordingly, the ranking features 120 of the search engine module 116 may be configured to be customizable by a customer (e.g., the network service provider 106) to address data 114 that is particular to the network service provider 106. In this way, the network service provider 106 may adjust the ranking features 120 to improve relevancy of search results for a search query, e.g., to provide a search result in response to a query submitted by the client device 104. A variety of different ranking features 120 may be leveraged by the search engine module 116 to rank items in a search result, further discussion of which may be found in relation to the discussion of FIG. 2.

Generally, any of the functions described herein can be implemented using software, firmware, hardware (e.g., fixed logic circuitry), or a combination of these implementations. The terms “module,” “functionality,” and “engine” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, a computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation showing the search engine module 116 in greater detail as being incorporated as part of a network service of the network service provider 106. The search engine module 116 in this example is illustrated as incorporated as part of the service manager module 112 of the network service provider 106. The search engine module 116, for instance, may provide a search result via the network 108 to a client device 104 in response to a search query received from the client device 104. This search query may relate to a variety of different data associated with the network service provider 106 as previously described in relation to FIG. 1.

An operator of the network service provider 106, in the illustrated instance, may purchase rights to use the search engine module 116 as part of the network services offered by the network service provider 106. Thus, although the search engine module 116 is illustrated as incorporated within the network service provider 106, this functionality may be made accessible to the network service provider 106 in a variety of ways, such as part of a platform that is accessible via the network 108, e.g., from a “cloud” implemented as part of one or more server farms.

As previously described, the search engine module 116 may be configured to leverage a variety of different ranking features 120 to determine relevancy of data 114 for a search query. The ranking features 120 may be exposed by the search engine module 116 for customization by the network service provider 106 to adjust how the ranking features 120 are applied to arrive at the search results. Examples of ranking features 120 are illustrated in FIG. 2 as use of multiple linear ranking stages 202, use of BM25 and a full text index 204, use of a minimum span on ranking stages 206, pre-calculation of a plurality of ranking models 208, use of a dynamic rank 210, use of more than one BM25 definition per stage 212, date/time transformations 214, freshness transformations 216, raw value transformations 218, query property rank 220, social distance 222, and so on. Each of these features is described in a corresponding section in the following discussion.

Multiple Ranking Stages 202

A search core of the search engine module 116 may be configured to support a plurality of ranking stages in a ranking model, such as linear and neural net stages. For example, the search engine module 116 may expose functionality such that the network service provider 106 may specify an arbitrary number of stages for inclusion as part of the ranking model.

These stages may be configured linearly in a series such that a subsequent stage is configured to consume an output of a previous stage. For example, a top “x” number of items of data from a previous stage may be consumed by a subsequent stage such that at least one item of data processed by the previous stage is not processed by the subsequent stage. This may be used to conserve resource usage in earlier stages and use more resource intensive techniques on subsequent stages. The exposure of this functionality may permit improved flexibility for customers in order to create their own custom models and ultimately improve ranking.

BM25 having a Full Text Index 204

The search core of the search engine module 116 may be configured to separate recall (e.g., properties that are to be matched by a query term for inclusion in a search result) from ranking (e.g., properties used for ranking). For example, a full text index may be used to support recall whereas BM25 may be used to perform ranking. Therefore, the full text index may be used to determine which documents are to be returned for a search query and BM25 may be used to determine a ranking for those documents. This functionality may be used to support properties from different full text indexes for use in ranking as further described below.

BM25 (also referred to as Okapi BM25) is a ranking functionality that may be employed by search engines to arrive at a ranking based on relevancy to a search query. BM25 has a number of versions, including BM25F, which is a version of BM25 that takes into account document structure and anchor text.

In one or more implementations described herein, the search engine of the search engine module 116 may utilize the following expression of a version of BM25F to arrive at a ranking:

$$BM 25 F = ( {\sum }_{t ∈ Q} \frac{{TF}_{t}^{′}}{k 1 + {TF}_{t}^{′}} \cdot log ( \frac{N}{{n}_{t}} ) \cdot {w}_{t} ) \cdot W$$

$${TF}_{t}^{′} = ( {\sum }_{p ∈ D} {w}_{p} \cdot \frac{{TF}_{t , p}}{( 1 - {b}_{p} ) + {b}_{p} \cdot \frac{{DL}_{p}}{{AVDL}_{p}}} )$$

In the above expression, “wₜ” is a weight parameter for term “t”; “k1” is a weight parameter for “tfprime” division; “wₚ” is a weight parameter for property “p”; “bₚ” is a length normalization parameter for property “p”; “TF_{t,p}” refers to term frequency (e.g., the number of times the term “t” appears in a property “p” of a ranked document); “DLₚ” is a length of the property “p” (number of terms); “AVDLₚ” is an average length of the property “p”; “N” is a number of documents in the corpus; “nₜ” is a number of documents containing the given query term “t”; and “W” is a weight parameter for the entire BM25F ranking feature as employed in a linear model.

In one or more implementations, “W”, “wₚ” and “bₚ” are configurable in rank models. Additionally, “W”, “wₚ” and “bₚ” may be overridden as query parameters, e.g., in order to ease relevancy tuning. The query parameter “wₜ” may be optional (0≦wₜ≦1) with default value 1.0. In this way, relevance tuning applications may then be able to show how a new parameter value affects the result set, without having to deploy and use a new rank profile.

Minimum Span on Ranking Stage 206

Minimum span is a proximity feature. In the implementations described herein, minimum span may apply to any stage employed by the service manager module 112 to perform ranking and thus increases flexibility over conventional techniques in which this feature was limited to later stages in ranking models. For example, minimum span may be employed even on an initial stage of a ranking model by the search engine module 116. Accordingly, an operator of the network service provider 106 may specify which stages may employ the minimum span as desired.

The service manager module 116, for instance, may take the top “N” document identifiers from a previous stage as an input, making it able to evaluate fewer documents or other data. However, other instances are also contemplated as described above. Relevant query terms may then be extracted from the query, and a position list for these words generated for each document or other item of data 114 using the positional indexes.

Minimum span refers to functionality that is configured to find the minimal span of the query terms in the document or other data 114. Thus, closer terms will are given a higher proximity value. In one or more implementations, this feature may also leverage a maximum span such that spans or distances between the terms higher than this maximum span are not considered.

Spans may be considered in the order terms appear in the query. First, each of the terms occurring in the documents is considered. If a span smaller than the maximum configured value (plus the number of query terms) exists that contains each of the query terms, this is considered the “best” minimum span in this example. If no such span exists, minimum span functionality is used to find the best span where one of the query terms is not part of the span. The rank value contribution from minimum span may be expressed as follows:

value=exp(log(best_diff_terms/best_min_span)*0.33);

where best_diff_terms is the number of different query terms used in the span, and best_min_span is the width of the span found.

Other proximity features are also contemplated. For example, an exact proximity feature may be used to find the longest sequence of consecutive ordered query terms in the document. This feature may be used to find a substring from a stream that contains the query phrase. If an exact match is not found, an attempt is made to find a sub string that contains some of query terms. This feature may also be employed to find query terms in the same order as found in the query. The rank value is the number of query terms found in the exact span.

Ranking Model Pre-Calculation 208

Pre-calculation may be used to arrive at rank scores for an item of data 114 (e.g., a document) before a search query is received, which may be used to improve responsiveness to a search query and may be leveraged for multiple models and tenants. The search engine module 116 in this instance may expose functionality to allow a user (e.g., an operator of the network service provider 106) to specify that pre-calculation may be performed for a plurality of ranking models (e.g., an arbitrary number of models) as applied to particular data 114 to arrive at rank scores from those models. In this way, the search engine module 116 may support customers that employ different ranking models.

For example, pre-calculation may be performed a master index of BM25 in which a term rank score (e.g., BM25+static) on first rank stage for the fifteen percent best documents (e.g., highest BM25+static) for the most common terms in the corpus per update group. The threshold that defines the most common terms may be configurable (where term occurs in more than X number of docs default: 500 000) and read at startup. Therefore, what is defined as common terms may be different for different update groups. Similar techniques may be employed for partitions besides the master index. In another example, a static rank may be pre-calculated, which is generally considered to be resource intensive and thus may have a significant impact on performance improvement through this recalculation.

Dynamic Rank 210

Dynamic rank increases flexibility as it uses synthetic fields (e.g., terms from query-able properties) and the term frequency of words in those fields for ranking, such as to employ a field that addresses scope and field of search. Conventionally, use of synthetic fields was limited to filtering results involved in recall but was not used in ranking. However, in one or more implementations described herein, this feature is used to boost particular terms in a ranking such that documents that have those terms are boosted (e.g., given a higher rank) than documents or other data 114 that does not have the terms. This feature may also be configured to support transformations.

Plurality of BM25 Definitions per Stage 212

Conventional techniques involved a limit of a single BM25 definition per stage in a ranking model. However, the techniques supported by the search engine module 116 described herein may expose functionality that supports a plurality of BM25 definitions per stage, e.g., an arbitrary number that is specifiable by a customer such as an operator of the network service provider 106.

Date/Time, Freshness, and Raw Value Transformations 214, 216, 218

Once a rank has been calculated, transformations may be applied (e.g., a formula) to adjust the values in the rankings. The date/time transformation 214 may employ functionality that leverages knowledge of a time, e.g., a current time at which a search query is received (e.g., from the client device 104) to apply a transformation. For example, this may include comparison of a current time to a date inside a document. The date may be associated with receipt of a search query in a variety of ways, such as a timestamp included by an originator of the query, by the search engine module 116 itself, and so on. This date may then be used to adjust rankings alone or in combination with text of the search query. For example, a birth date for today that is included as part of a search query may be considered as having increased importance over birthdays in the past because the birthdays have expired.

For a freshness transformation 216, a similar comparison of dates may be performed to calculate an age of an item of data 114, a document. For instance, the freshness transformation 216 may be used to give a higher ranking to a document that is newer than a ranking given to an older document. Thus, the search engine module 116 may expose this functionality to enable a customer to specify a degree to which these transformations may be applied to items of data 114 in a search result to customize the rankings.

For raw value transformations 218, a transformation is performed based on the query property and the raw value read from the index. Typical transformation examples include a difference operator (res=raw_value−query_property_value) and the equal transformation (res=raw_value==query_property_value).

Query Property Rank 220

Any query property that is set in the query tree can be matched against any property in the index and contribute to the rank score. This flexibility may be used to support a variety of different scenarios and ranking features and thus exposure of this functionality may support a wide degree of customization for a customer of the search engine module 114. For instance, a query may be communicated along with a property that may be leveraged by the search engine module 114 to rank items of data 114 in a search result. For example, the search query may be communicated with a property indicating a location of the client device 104 (e.g., IP address), a language supported by the client device 104, and so on. These proprieties may then be used to rank items of data 114 in the search result accordingly.

Social Distance 222

Social distance 222 refers to functionality that may be used to rank items of data 114 based on a social distance between an originator of a search query and one or more uses associated with the item of data. The search query, for instance, may be associated with a user ID of the originator of the query. This ID may then be used to determine a social distance between the originator and users associated with the items of data 114, e.g., authors, commenters, contributors, viewers, and so on. This may be determined in a variety of ways, such as to leverage knowledge of a social network service (e.g., by knowing “friends” of the originator of the query), contact information, membership in one or more organizations, and so on.

Example Procedures

The following discussion describes search ranking feature techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

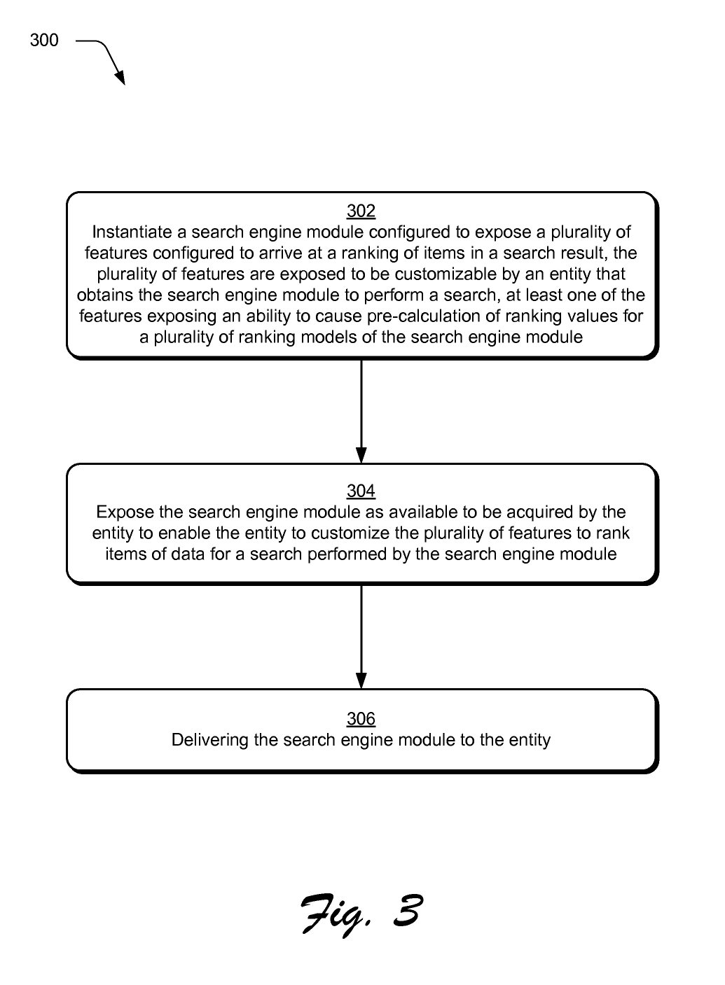

FIG. 3 depicts a procedure 300 in an example implementation in which a search engine module is exposed by a search engine developer for availability to one or more customers, such as a network service provider. A search engine module is instantiated that is configured to expose a plurality of features configured to arrive at a ranking of items in a search result, the plurality of features are exposed to be customizable by an entity that obtains the search engine module to perform a search, at least one of the features exposing an ability to cause pre-calculation of ranking values for a plurality of ranking models of the search engine module (block 302). The search engine developer 102, for instance, may code the search engine module 116 to support features used for ranking that are customizable by a customer that obtains the search engine module 116. A variety of different features may be exposed as previously described in relation to FIG. 2.

The search engine module is exposed as available to be acquired by the entity to enable the entity to customize the plurality of features to rank items of data for a search performed by the search engine module (block 304). The search engine developer 102, for instance, may expose the search engine module 116 as available via an ecommerce network service that is accessible by one or more customers. A variety of other examples of exposure of availability of the search engine module 116 are also contemplated.

The search engine module is communicated to the entity (block 306). This may also be performed in a variety of ways, such as downloaded via the network 108, communicated via a computer-readable storage medium through physical delivery of the medium, and so forth.

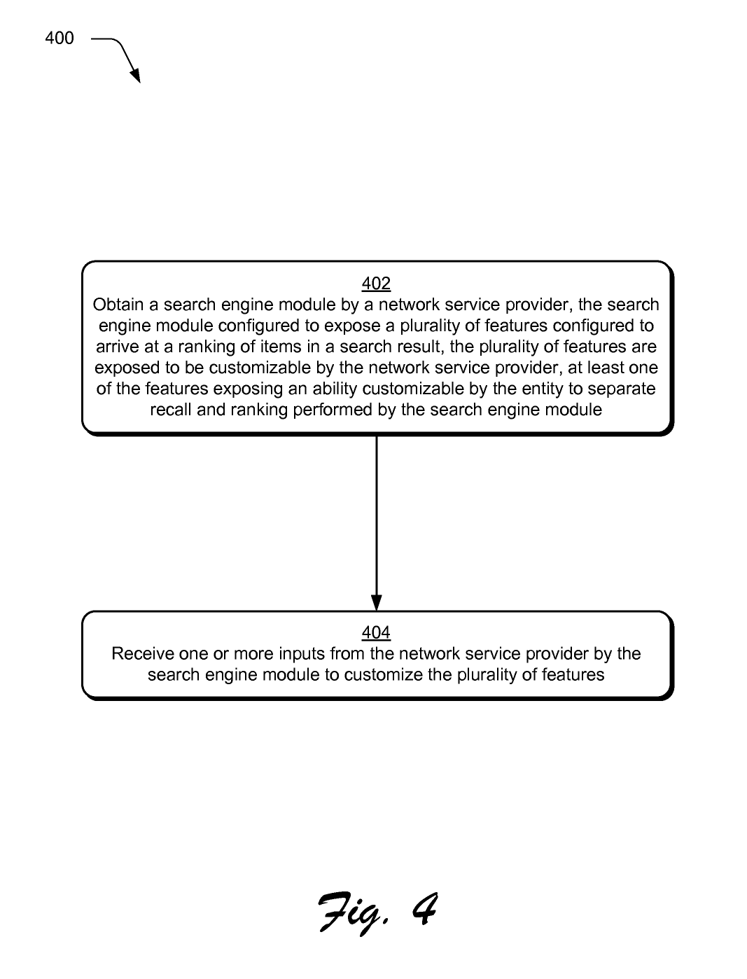

FIG. 4 depicts a procedure 400 in an example implementation in which the search engine module exposed by the search engine developer in FIG. 3 is obtained by a customer for customization. A search engine module is obtained by a network service provider, the search engine module configured to expose a plurality of features configured to arrive at a ranking of items in a search result, the plurality of features are exposed to be customizable by the network service provider, at least one of the features exposing an ability to customizable by the entity to separate recall and ranking performed by the search engine module (block 402). As previously described, the at least one feature may separate recall (e.g., properties that are to be matched by a query term for inclusion in a search result) from ranking (e.g., properties used for ranking). This may be performed in a variety of different ways, such as through use of a full text index to support recall and a version of BM25 to perform ranking. Therefore, the full text index may be used to determine which documents are to be returned for a search query and BM25 may be used to determine a ranking for those documents. This functionality may be used to support properties from different full text indexes.

One or more inputs are received from the network service provider by the search engine module to customize the plurality of features (block 404). The search engine module 116 may receive inputs from an operator of the network service provider 106 to customize ranking performed using the features exposed to the operator by the search engine module 116. A variety of other customers are also contemplated as previously described.

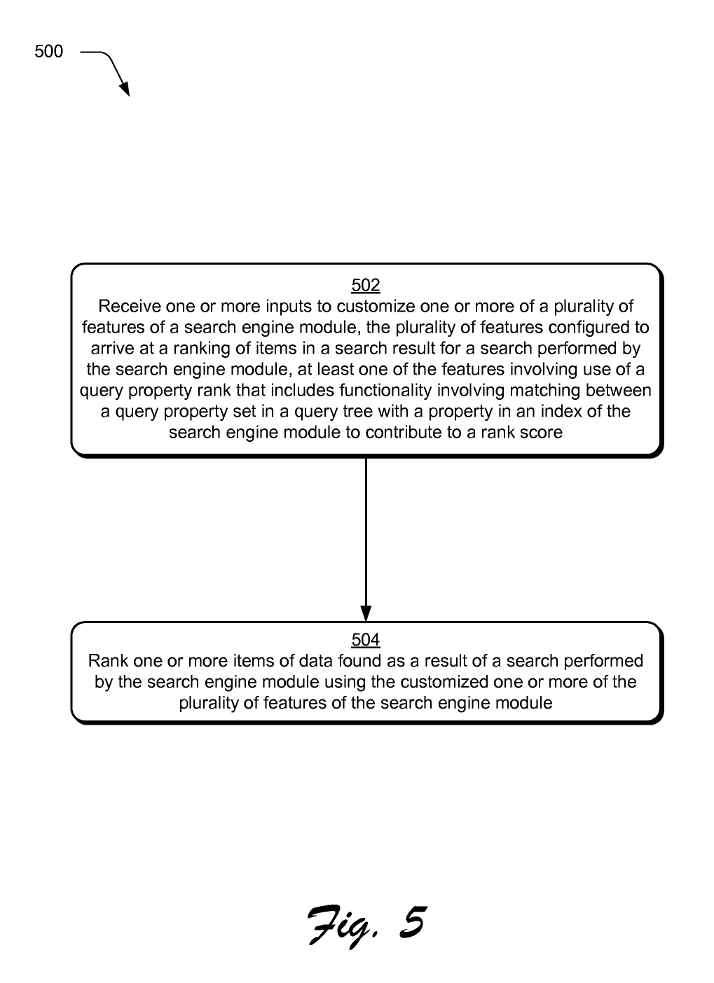

FIG. 5 depicts a procedure 500 in an example implementation in which a customer that obtained the search engine module from the search engine developer provides inputs to customize features used in ranking by the search engine module. One or more inputs are received to customize one or more of a plurality of features of a search engine module, the plurality of features configured to arrive at a ranking of items in a search result for a search performed by the search engine module, at least one of the features involving use of a query property rank that supports functionality involving matching between a query property set in a query tree with a property in an index of the search engine module to contribute to a rank score (block 502). The search engine module 116, for instance, may expose a user interface to a customer to customize ranking features 120 of the search engine module 116.

One or more items of data found as a result of a search performed by the search engine module are ranked using the customized one or more of the plurality of features of the search engine module (block 504). The search engine module 116 may then using the ranking features 120 that are customized by the customer to rank items returned in a search for inclusion in a search result.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method performed by one or more computing devices, the method comprising:
instantiating a search engine module configured to expose a plurality of features configured to arrive at a ranking of items in a search result, the plurality of features are exposed to be customizable by an entity that obtains the search engine module to perform a search, at least one of the features exposing an ability to cause pre-calculation of ranking values for a plurality of ranking models of the search engine module; and
exposing the search engine module as available to be acquired by the entity to enable the entity to customize the plurality of features configured to arrive at the ranking of items in the search result.

2. A method as described in claim 1, wherein another one of the features are exposed to be customizable by the entity to support three or more linear ranking stages in a respective said ranking model.

3. A method as described in claim 1, wherein:
another one of the features are exposed to be customizable by the entity to separate recall and ranking;
recall involves properties that are to be matched by a query term for inclusion in a search result; and
ranking involves properties that are to be used for ranking items of data in the search result.

4. A method as described in claim 3, wherein the recall is performed using full text index and ranking is performed using one or more versions of BM25.

5. A method as described in claim 4, wherein at least one said version of BM25 used by the search engine module is BM25F.

6. A method as described in claim 1, wherein another one of the features are exposed to be customizable by the entity is to apply minimum span functionality to an initial stage in a ranking model utilized by the search engine module, the minimum span functionality configured to find a minimal span of query terms in an item of data searched by the search engine module.

7. A method as described in claim 6, wherein the minimum span functionality is also configured to leverage a maximum span such that spans between the query terms that are greater than an amount defined by the maximum span are not considered by the search engine module.

8. A method as described in claim 1, wherein another one of the features are exposed to be customizable by the entity to employ dynamic rank to support synthetic fields that are configured as terms from query-able properties and term frequency of words in those fields for ranking.

9. A method as described in claim 1, wherein another one of the features are exposed to be customizable by the entity to employ a plurality of BM25 definitions per a single stage in a ranking model.

10. A method as described in claim 1, wherein another one of the features are exposed to be customizable by the entity to specify application of a transformation that leverages a current time associated with a search query that is received by the search engine module to perform a search.

11. A method as described in claim 10, wherein the transformation is a date/time transformation or a freshness transformation.

12. A method as described in claim 1, wherein another one of the features are exposed to be customizable by the entity to specify application of a raw value transformation that is based on a query property and a raw value read from an index.

13. A method as described in claim 1, wherein another one of the features are exposed to be customizable by the entity to utilize a query property rank that includes functionality involving matching between a query property set in a query tree with a property in an index of the search engine module to contribute to a rank score.

14. A method as described in claim 1, wherein another one of the features are exposed to be customizable by the entity to employ functionality to rank items of data based on a social distance between an originator of a search query and one or more users associated with an item of data that is subject to a search performed by the search engine module.

15. A method performed by one or more computing devices, the method comprising:
obtaining a search engine module by a network service provider, the search engine module configured to expose a plurality of features configured to arrive at a ranking of items in a search result, the plurality of features are exposed to be customizable by the network service provider, at least one of the features exposing an ability customizable by the entity to separate recall and ranking performed by the search engine module; and
receiving one or more inputs from the network service provider by the search engine module to customize the plurality of features.

16. A method as described in claim 15, wherein:
recall involves properties that are to be matched by a query term for inclusion in a search result using a full text index; and
ranking involves properties that are to be used for ranking items of data in the search result using one or more versions of BM25.

17. A method as described in claim 15, wherein another one of the features are exposed to be customizable by the network service provider to support three or more linear ranking stages in a ranking module.

18. A method as described in claim 15, wherein another one of the features are exposed to be customizable by the network service provider to apply minimum span functionality to an initial stage in a ranking model utilized by the search engine module, the minimum span functionality configured to find a minimal span of query terms in an item of data search by the search engine module.

19. A method performed by one or more computing devices, the method comprising:
receiving one or more inputs to customize one or more of a plurality of features of a search engine module, the plurality of features configured to arrive at a ranking of items in a search result for a search performed by the search engine module, at least one of the features involving use of a query property rank that includes functionality involving matching between a query property set in a query tree with a property in an index of the search engine module to contribute to a rank score; and
ranking one or more items of data found as a result of a search performed by the search engine module using the customized one or more of the plurality of features of the search engine module.

20. A method as described in claim 19, wherein another one of the features are customized using the one or more inputs to support three or more linear ranking stages in a ranking module utilized by the search engine module.
